(19) United States
(12) Patent Application Publication
(10) Pub. No.: US 2020/0313163 A1
(43) Pub. Date: Oct. 1, 2020

(54) NON-AQUEOUS ELECTROLYTE SECONDARY BATTERY AND METHOD FOR MANUFACTURING SAME

(71) Applicant: SANYO Electric Co., Ltd., Osaka (JP)

(72) Inventors: Fumiya Kanetake, Hyogo (JP); Shinichi Yamami, Hyogo (JP); Kentaro Takahashi, Hyogo (JP)

(73) Assignee: SANYO Electric Co., Ltd., Osaka (JP)

(21) Appl. No.: 16/736,150

(22) Filed: Jan. 7, 2020

(30) Foreign Application Priority Data
Mar. 26, 2019 (JP) 2019-057594

(51) Int. Cl. H01M 4/133; H01M 4/1393; H01M 4/36; H01M 10/0525; H01M 4/587; C01B 32/20

(52) U.S. Cl. CPC H01M 4/133; H01M 4/1393; H01M 4/366; C04B 2235/54; H01M 4/587; C01B 32/20; H01M 10/0525

(57) ABSTRACT

In a non-aqueous electrolyte secondary battery, a negative electrode includes covered graphite particles in each of which a surface of a graphite particle is covered with amorphous carbon, styrene-butadiene rubber, and at least one of carboxymethyl cellulose and a salt of carboxymethyl cellulose. The amorphous carbon included in each of the covered graphite particles includes an amorphous carbon layer formed of a first amorphous carbon and amorphous carbon particles formed of a second amorphous carbon. The second amorphous carbon has a higher electrical conductivity than the first amorphous carbon, the amorphous carbon particles have a BET specific surface area of 37 to 47 m²/g, the styrene-butadiene rubber has an average primary particle size of 150 to 210 nm, and at least one of the carboxymethyl cellulose and the salt of carboxymethyl cellulose has a weight average molecular weight of 3.7×10⁵ to 4.3×10⁵.

### CROSS REFERENCE TO RELATED APPLICATIONS

The present invention application claims priority to Japanese Patent Application No. 2019-057594 filed in the Japan Patent Office on Mar. 26, 2019, the entire contents of which are incorporated herein by reference.

### BACKGROUND OF THE INVENTION

### Field of the Invention

The present disclosure relates to a non-aqueous electrolyte secondary battery and a method for manufacturing the same.

### Description of Related Art

In order to improve battery characteristics, a non-aqueous electrolyte secondary battery has been proposed which includes a negative plate including uncovered flake graphite particles whose surfaces are not covered, and covered graphite particles in each of which a surface of a graphite particle is covered with a covering layer containing amorphous carbon particles and an amorphous carbon layer (refer to Japanese Patent No. 5991717 (Patent Document 1)).

### BRIEF SUMMARY OF THE INVENTION

In non-aqueous electrolyte secondary batteries, it is important to improve battery characteristics, such as low-temperature regeneration characteristics, cycle characteristics, and high-temperature storage characteristics.

In known techniques, including the technique disclosed in Patent Document 1, there is still a room for improvement regarding the battery characteristics.

A non-aqueous electrolyte secondary battery according to an aspect of the present disclosure is a non-aqueous electrolyte secondary battery including a positive electrode, a negative electrode, and a non-aqueous electrolyte, in which the negative electrode includes covered graphite particles in each of which a surface of a graphite particle is covered with amorphous carbon, styrene-butadiene rubber, and at least one of carboxymethyl cellulose and a salt of carboxymethyl cellulose; in which the amorphous carbon included in each of the covered graphite particles includes an amorphous carbon layer formed of a first amorphous carbon and amorphous carbon particles formed of a second amorphous carbon; and in which the second amorphous carbon has a higher electrical conductivity than the first amorphous carbon, the amorphous carbon particles have a BET specific surface area of 37 to 47 m²/g, the styrene-butadiene rubber has an average primary particle size of 150 to 210 nm, and at least one of the carboxymethyl cellulose and the salt of carboxymethyl cellulose has a weight average molecular weight of 3.7×10⁵ to 4.3×10⁵.

A method for manufacturing a non-aqueous electrolyte secondary battery according to another aspect of the present disclosure is a method for manufacturing a non-aqueous electrolyte secondary battery which includes a positive electrode, a negative electrode, and a non-aqueous electrolyte, in which the negative electrode includes covered graphite particles in each of which a surface of a graphite particle is covered with amorphous carbon, styrene-butadiene rubber, and at least one of carboxymethyl cellulose and a salt of carboxymethyl cellulose; in which the amorphous carbon included in each of the covered graphite particles includes an amorphous carbon layer formed of a first amorphous carbon and amorphous carbon particles formed of a second amorphous carbon; in which the second amorphous carbon has a higher electrical conductivity than the first amorphous carbon; and in which the covered graphite particles are obtained by heating the graphite particles whose surfaces have adhering thereto the amorphous carbon particles with a BET specific surface area of 37 to 47 m²/g and a raw material for the first amorphous carbon, so that the raw material for the first amorphous carbon is transformed into the first amorphous carbon, the method including a step of preparing a slurry for a negative electrode active material layer including the covered graphite particles, styrene-butadiene rubber having an average primary particle size of 150 to 210 nm, and at least one of carboxymethyl cellulose and a salt of carboxymethyl cellulose having a weight average molecular weight of 3.7×10⁵ to 4.3×10⁵; a step of applying the slurry for a negative electrode active material layer onto a negative electrode core body; and a step of drying the slurry for a negative electrode active material layer.

According to the present disclosure, a non-aqueous electrolyte secondary battery having excellent low-temperature regeneration characteristics, cycle characteristics, and high-temperature storage characteristics can be provided.

### BRIEF DESCRIPTION OF THE SEVERAL VIEWS OF THE DRAWINGS

FIG. 1 is a cross-sectional view of a non-aqueous electrolyte secondary battery according to an example of an embodiment.

FIG. 2 is a plan view of the non-aqueous electrolyte secondary battery according to the example of the embodiment.

FIG. 3 is a cross-sectional view schematically showing a negative electrode active material according to an example of an embodiment.

FIG. 4 is an enlarged cross-sectional view schematically showing the negative electrode active material according to the example of the embodiment, in the vicinity of amorphous carbon particles.

### DETAILED DESCRIPTION OF THE INVENTION

The present inventors have found that, in the case where a negative electrode includes covered graphite particles in each of which a surface of a graphite particle is covered with amorphous carbon, styrene-butadiene rubber, and at least one of carboxymethyl cellulose and a salt of carboxymethyl cellulose, by configuring such that the amorphous carbon included in each of the covered graphite particles includes an amorphous carbon layer formed of a first amorphous carbon and amorphous carbon particles formed of a second amorphous carbon, the second amorphous carbon has a higher electrical conductivity than the first amorphous carbon, the amorphous carbon particles have a BET specific surface area of 37 to 47 m²/g, the styrene-butadiene rubber has an average primary particle size of 150 to 210 nm, and at least one of the carboxymethyl cellulose and the salt of carboxymethyl cellulose has a weight average molecular weight of 3.7×10⁵ to 4.3×10⁵, a non-aqueous electrolyte secondary battery having excellent low-temperature regeneration characteristics, cycle characteristics, and high-temperature storage characteristics can be obtained.

By using, as a negative electrode active material, covered graphite particles with a high electrical conductivity, in each of which a surface of a graphite particle is covered with two types of amorphous carbon (the first amorphous carbon and the second amorphous carbon), a good protective coating derived from the non-aqueous electrolyte is uniformly formed on the surface of the negative electrode active material. Thus, a non-aqueous electrolyte secondary battery having excellent low-temperature regeneration characteristics can be obtained.

Furthermore, in the covered graphite particles, by setting the BET specific surface area of amorphous carbon particles formed of the second amorphous carbon on the surface of each of the graphite particles to 37 m²/g or more, the charge transfer resistance on the surface of the negative electrode active material can be reduced, and therefore, low-temperature regeneration characteristics are further improved. Moreover, by setting the BET specific surface area of amorphous carbon particles formed of the second amorphous carbon to 47 m²/g or less, styrene-butadiene rubber particles can be suppressed from being intensively bonded to the amorphous carbon particles. Thus, in the negative electrode active material layer, the styrene-butadiene rubber particles are prevented from being present locally in the vicinity of the amorphous carbon particles. Accordingly, the styrene-butadiene rubber particles are likely to be dispersed more uniformly in the negative electrode active material layer. Therefore, even when the number of charge/discharge cycles increases, the individual negative electrode active material particles are not in an isolated state in the negative electrode active material layer, and a good conductive network can be maintained in the negative electrode active material layer. Accordingly, a non-aqueous electrolyte secondary battery having excellent cycle characteristics can be obtained.

By setting the average primary particle size of the styrene-butadiene rubber to 150 nm or more, it is possible to effectively suppress the styrene-butadiene rubber particles from entering recessed portions of the amorphous carbon particles formed of the second amorphous carbon having a BET specific surface area of 37 to 47 m²/g. Thus, the styrene-butadiene rubber particles can be suppressed from being intensively bonded to the amorphous carbon particles. Therefore, in the negative electrode active material layer, the styrene-butadiene rubber particles are prevented from being present locally in the vicinity of the amorphous carbon particles. Accordingly, the styrene-butadiene rubber particles are likely to be dispersed more uniformly in the negative electrode active material layer. Therefore, even when the number of charge/discharge cycles increases, the individual negative electrode active material particles are not in an isolated state in the negative electrode active material layer, and a good conductive network can be maintained in the negative electrode active material layer. Accordingly, a non-aqueous electrolyte secondary battery having excellent cycle characteristics can be obtained.

By setting the average primary particle size of the styrene-butadiene rubber to 210 nm or less, in the case where the negative electrode active material layer is compressed during production of a negative plate, it is possible to effectively suppress the styrene-butadiene rubber from covering a large area of the surface of the negative electrode active material due to crushing of the styrene-butadiene rubber particles. Accordingly, it is possible to suppress an increase in the region covered with the styrene-butadiene rubber on the surface of the negative electrode active material. Therefore, a non-aqueous electrolyte secondary battery having more excellent low-temperature regeneration characteristics can be obtained.

In addition, since the styrene-butadiene rubber is dispersed more uniformly in the negative electrode active material layer, the resistance on the surface of the negative electrode active material is likely to become uniform. Therefore, since the styrene-butadiene rubber is dispersed more uniformly in the negative electrode active material layer, a good protective coating derived from the non-aqueous electrolyte is more uniformly formed on the surface of the negative electrode active material. Accordingly, a non-aqueous electrolyte secondary battery having excellent high-temperature storage characteristics can be obtained.

By setting the weight average molecular weight of at least one of the carboxymethyl cellulose and the salt of carboxymethyl cellulose to 3.7×10⁵ or more, at least one of the carboxymethyl cellulose and the salt of carboxymethyl cellulose can cover the amorphous carbon particles formed of the second amorphous carbon in a desirable state. Therefore, side reactions between the amorphous carbon particles and the non-aqueous electrolyte can be effectively suppressed. Accordingly, a non-aqueous electrolyte secondary battery having excellent high-temperature storage characteristics can be obtained. Note that as the weight average molecular weight of at least one of the carboxymethyl cellulose and the salt of carboxymethyl cellulose increases, at least one of the carboxymethyl cellulose and the salt of carboxymethyl cellulose is more likely to become entangled with the amorphous carbon particles, and at least one of the carboxymethyl cellulose and the salt of carboxymethyl cellulose can cover the amorphous carbon particles in a desirable state.

By setting the weight average molecular weight of at least one of the carboxymethyl cellulose and the salt of carboxymethyl cellulose to 4.3×10⁵ or less, occurrence of pinholes in the negative electrode active material layer can be effectively prevented.

Since amorphous carbon has higher hydrophobicity than graphite, at least one of the carboxymethyl cellulose and the salt of carboxymethyl cellulose is considered to preferentially bind to the amorphous carbon particles formed of the second amorphous carbon. As the weight average molecular weight of at least one of the carboxymethyl cellulose and the salt of carboxymethyl cellulose increases, at least one of the carboxymethyl cellulose and the salt of carboxymethyl cellulose is more likely to become entangled with the amorphous carbon particles, and the binding property of at least one of the carboxymethyl cellulose and the salt of carboxymethyl cellulose with the amorphous carbon particles increases.

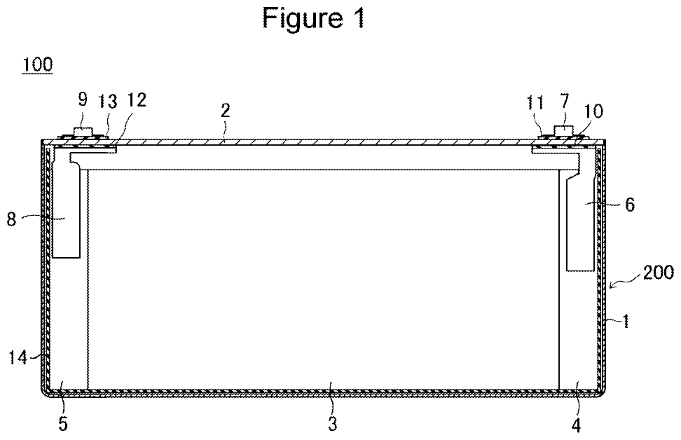

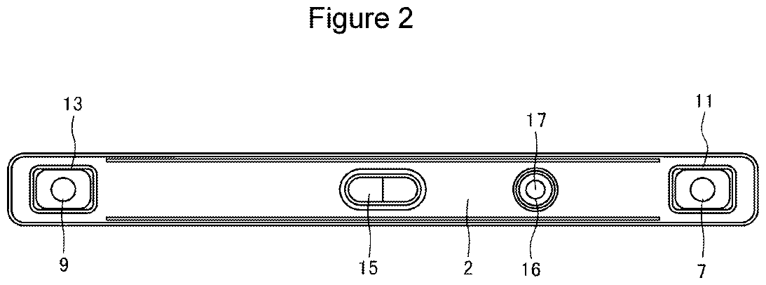

An example of an embodiment of the present disclosure will be described in detail below with reference to the drawings. FIGS. 1 and 2 show a non-aqueous electrolyte secondary battery 100 which is a prismatic battery provided with a prismatic battery case 200, according to the example of the embodiment.

As shown in FIGS. 1 and 2, the non-aqueous electrolyte secondary battery 100 includes a prismatic, closed-bottom tubular case 1 and a sealing plate 2 which seals openings of the case 1. The case 1 and the sealing plate 2 constitute the battery case 200. The case 1 contains a flat electrode body 3 in which a belt-shaped positive electrode and a belt-shaped negative electrode are wound with a belt-shaped separator interposed therebetween, and a non-aqueous electrolytic solution. The electrode body 3 has a positive electrode core body exposed portion 4 disposed at one end in the winding axis direction and a negative electrode core body exposed portion 5 disposed at the other end in the winding axis direction.

A positive electrode current collector plate 6 is connected to the positive electrode core body exposed portion 4, and the positive electrode current collector plate 6 and a positive electrode terminal 7 are electrically connected to each other. An inner side insulating member 10 is arranged between the positive electrode current collector plate 6 and the sealing plate 2, and an outer side insulating member 11 is arranged between the positive electrode terminal 7 and the sealing plate 2. A negative electrode current collector plate 8 is connected to the negative electrode core body exposed portion 5, and the negative electrode current collector plate 8 and a negative electrode terminal 9 are electrically connected to each other. An inner side insulating member 12 is arranged between the negative electrode current collector plate 8 and the sealing plate 2, and an outer side insulating member 13 is arranged between the negative electrode terminal 9 and the sealing plate 2.

An insulating sheet 14 is arranged between the electrode body 3 and the case 1 so as to surround the electrode body 3. The sealing plate 2 is provided with a gas discharge valve 15 that breaks when the pressure inside the battery case 200 reaches a predetermined value or more, thereby discharging gas inside the battery case 200 to the outside thereof. Furthermore, the sealing plate 2 is provided with an electrolytic solution injection hole 16. After a non-aqueous electrolytic solution is injected into the battery case 200, the electrolytic solution injection hole 16 is sealed with a sealing plug 17.

[Positive Electrode]

A positive electrode includes a positive electrode core body and a positive electrode active material layer disposed on the positive electrode core body. As the positive electrode core body, for example, a foil of a metal, such as aluminum, that is stable in the potential range of the positive electrode may be used. Preferably, the positive electrode active material layer contains a positive electrode active material, a conductive material, and a binder, and is provided on each of both surfaces of the positive electrode core body. The positive electrode can be produced, for example, by applying a slurry for a positive electrode active material layer containing a positive electrode active material, a conductive material, a binder, and the like onto a positive electrode core body, drying the resulting coating films, followed by compression, thereby forming a positive electrode active material layer on each of both surfaces of the positive electrode core body.

The positive electrode active material contains a lithium metal composite oxide as a main component. Examples of the metal element contained in the lithium metal composite oxide include Ni, Co, Mn, Al, B, Mg, Ti, V, Cr, Fe, Cu, Zn, Ga, Sr, Zr, Nb, In, Sn, Ta, and W. A preferred example of the lithium metal composite oxide is a lithium metal composite oxide containing at least one of Ni, Co, and Mn. Specific examples thereof include a lithium metal composite oxide containing Ni, Co, and Mn, and a lithium metal composite oxide containing Ni, Co, and Al. In addition, particles of an inorganic compound, such as tungsten oxide, aluminum oxide, or a lanthanide-containing compound, may adhere to the surfaces of the lithium metal composite oxide particles.

Examples of the conductive material contained in the positive electrode active material layer include carbon materials, such as carbon black, acetylene black, Ketjen black, and graphite. Examples of the binder contained in the positive electrode active material layer include fluorine-based resins such as polytetrafluoroethylene (PTFE) and polyvinylidene fluoride (PVDF), polyacrylonitrile (PAN), polyimide resins, acrylic resins, and polyolefin resins.

[Negative Electrode]

A negative electrode includes a negative electrode core body and a negative electrode active material layer disposed on the negative electrode core body. As the negative electrode core body, for example, a foil of a metal, such as copper, that is stable in the potential range of the negative electrode may be used. Preferably, the negative electrode active material layer contains a negative electrode active material and a binder, and is provided on each of both surfaces of the negative electrode core body. The negative electrode can be produced, for example, by applying a slurry for a negative electrode active material layer containing a negative electrode active material, a binder, and the like onto a negative electrode core body, drying the resulting coating films, followed by compression, thereby forming a negative electrode active material layer on each of both surfaces of the negative electrode core body.

Although details will be described later, the negative electrode active material layer contains covered graphite particles in which a first amorphous carbon and a second amorphous carbon having a higher electrical conductivity than the first amorphous carbon adhere to the surfaces of graphite particles, styrene-butadiene rubber having an average primary particle size of 150 to 210 nm, and at least one of carboxymethyl cellulose and a salt of carboxymethyl cellulose having a weight average molecular weight of 3.7×10⁵ to 4.3×10⁵. In the case where the negative electrode active material layer contains both carboxymethyl cellulose and a salt of carboxymethyl cellulose, the weight average molecular weight of the carboxymethyl cellulose and the salt of carboxymethyl cellulose is 3.7×10⁵ to 4.3×10⁵. In this specification, the weight average molecular weight (Mw) refers to a value measured by gel permeation chromatography (GPC).

The negative electrode active material layer contains covered graphite particles as a negative electrode active material. The covered graphite particles are particles in which two types of amorphous carbon adhere to the surfaces of graphite particles, such as natural graphite (e.g., flake graphite, massive graphite, or earthy graphite) or artificial graphite (e.g., massive artificial graphite (MAG) or graphitized mesophase carbon microbeads (MCMB)). Furthermore, as a negative electrode active material, a metal, such as Si, that forms an alloy with lithium, an alloy containing the metal, a compound containing the metal, or the like may also be used within the range not impairing the object of the present disclosure. Examples of the negative electrode active material other than graphite include silicon oxide represented by SiOₓ.

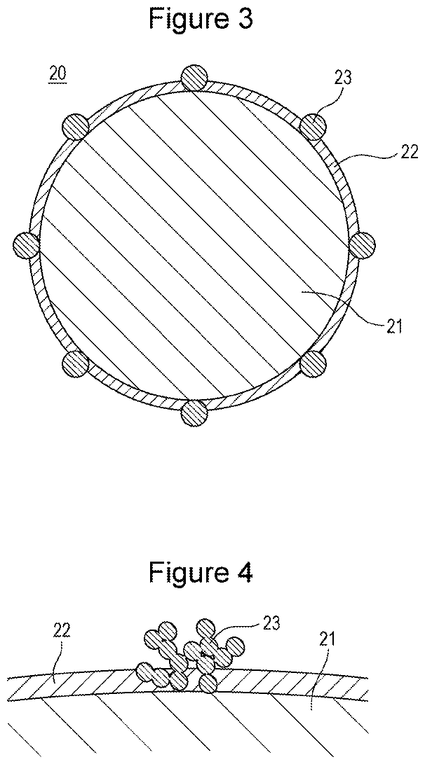

As illustrated in FIG. 3, a covered graphite particle 20 includes a graphite particle 21 and two types of amorphous carbon adhering to a surface of the graphite particle 21. The two types of amorphous carbon include, as described above, a first amorphous carbon and a second amorphous carbon having a higher electrical conductivity than the first amorphous carbon. Preferably, an amorphous carbon layer 22 formed of the first amorphous carbon is formed on the surface of the graphite particle 21, and amorphous carbon particles 23 formed of the second amorphous carbon adhere thereto. Because of the function of amorphous carbon, the covered graphite particle 20 has a high electrical conductivity.

The amorphous carbon layer 22 is preferably formed so as to cover the entire surface of the graphite particle 21. The amorphous carbon layer 22 is preferably formed as a continuous layer which covers the entire surface of the graphite particle 21. On the other hand, the amorphous carbon particles 23 are interspersed on the surface of the graphite particle 21. Preferably, the amorphous carbon particles 23 uniformly adhere to the entire surface of the graphite particle 21 without being unevenly distributed on a part of the surface of the graphite particle 21.

Preferably, the first amorphous carbon constituting the amorphous carbon layer 22 is, for example, a fired product of pitch. That is, pitch can be used as a raw material for the first amorphous carbon. The pitch may be either petroleum pitch or coal pitch. The amorphous carbon layer 22 is formed, for example, by allowing pitch to adhere to the entire surfaces of the graphite particles 21, and then performing firing in an inert atmosphere at a temperature of 900° C. to 1,500° C., preferably 1,200° C. to 1,300° C. The mass ratio of the amorphous carbon layer 22 in the covered graphite particle 20 is preferably 1% to 10% by mass, and more preferably 2% to 5% by mass, relative to the total mass of the covered graphite particle 20.

The amorphous carbon particles 23 may adhere directly to the surface of the graphite particle 21, or may adhere to the surface of the graphite particle 21 with the amorphous carbon layer 22 interposed therebetween. Furthermore, the amorphous carbon particles 23 may be covered with the amorphous carbon layer 22. For example, some amorphous carbon particles 23 may be embedded in the amorphous carbon layer 22. As illustrated in FIG. 3, the surfaces of the amorphous carbon particles 23 may be partially exposed without being covered with the amorphous carbon layer 22. FIG. 4 is an enlarged cross-sectional view showing the vicinity of amorphous carbon particles 23 in a covered graphite particle 20. As shown in FIG. 4, the amorphous carbon particles 23 preferably have irregular shaped surfaces.

Preferably, the second amorphous carbon constituting the amorphous carbon particles 23 is, for example, carbon black. Carbon black is suitable as the amorphous carbon particles 23 because it has a high electrical conductivity and a small change in volume during charging/discharging. The amorphous carbon particles 23 can have an average particle size of, for example, 30 to 200 nm. The average particle size is calculated in such a manner that 100 amorphous carbon particles 23 are selected from an electron microscope image of the amorphous carbon particles 23, the longest distance across each of the particles selected is measured, and the measured values are averaged. Furthermore, the dibutyl phthalate (DBP) absorption amount of the amorphous carbon particles 23 can be, for example, 35 to 220 mL/100 g.

The mass ratio of the amorphous carbon particles 23 in the covered graphite particle 20 is preferably higher than that of the amorphous carbon layer 22. That is, preferably, the second amorphous carbon is present in a larger amount, by mass, than the first amorphous carbon on the surface of the graphite particle 21. The mass ratio of the amorphous carbon particles 23 is preferably 2% to 15% by mass, and more preferably 5% to 9% by mass, relative to the total mass of the covered graphite particle 20.

The presence of amorphous carbon can be confirmed by Raman spectroscopic measurement. A peak at around 1,360 cm⁻¹ in the Raman spectrum using an argon laser with a wavelength of 5,145 angstrom is a peak derived from amorphous carbon and is hardly observed in graphite carbon. On the other hand, a peak at around 1,580 cm⁻¹ is a peak peculiar to graphite carbon. As for the ratio (I₁₃₆₀/I₁₅₈₀) of a peak intensity (I₁₃₆₀) at around 1,360 cm⁻¹ to a peak intensity (I₁₅₈₀) at around 1,580 cm⁻¹, for example, the graphite particle 21 has a ratio of 0.10 or less, and the covered graphite particle 20 has a ratio of 0.13 or more.

The central particle size (D50) of the covered graphite particles 20 is, for example, 5 to 20 μm, and preferably 8 to 13 μm. The central particle size means a median size at a cumulative volume of 50% in a particle size distribution measured by a laser diffraction scattering particle size distribution measurement apparatus (e.g., LA-750 manufactured by HORIBA, Ltd). When the central particle size (D50) of the covered graphite particles 20 is in the range described above, coating properties of the slurry for a negative electrode active material layer are improved, and the adhesion strength of the negative electrode active material layer to the core body is further increased. Furthermore, the number of contact points between the particles can be increased, and the electrical conductivity of the negative electrode active material layer is further improved.

As described above, the negative electrode active material layer includes at least one of carboxymethyl cellulose and a salt of carboxymethyl cellulose having a weight average molecular weight of 3.7×10⁵ to 4.3×10⁵. Examples of the salt of carboxymethyl cellulose include sodium carboxymethyl cellulose and ammonium carboxymethyl cellulose. At least one of the carboxymethyl cellulose and the salt of carboxymethyl cellulose may function as a binder or may have a viscosity adjusting function of the slurry for a negative electrode active material layer.

In the negative electrode active material layer, at least one of the carboxymethyl cellulose and the salt of carboxymethyl cellulose adheres to the surfaces of the covered graphite particles 20. At least one of the carboxymethyl cellulose and the salt of carboxymethyl cellulose covers the surfaces of the amorphous carbon particles 23 present on the surface of each covered graphite particle 20. Since at least one of the carboxymethyl cellulose and the salt of carboxymethyl cellulose covers the surfaces of the amorphous carbon particles 23, occurrence of side reactions between amorphous carbon particles 23 and the non-aqueous electrolyte can be effectively suppressed when the non-aqueous electrolyte secondary battery 100 is stored at high temperatures. Therefore, high-temperature storage characteristics are improved. At least one of the carboxymethyl cellulose and the salt of carboxymethyl cellulose having a weight average molecular weight of 3.7×10⁵ to 4.3×10⁵ has a high affinity for the amorphous carbon particles 23 and can efficiently cover the amorphous carbon particles 23. When the weight average molecular weight of at least one of the carboxymethyl cellulose and the salt of carboxymethyl cellulose is less than 3.7×10⁵, the amorphous carbon particles 23 cannot be covered sufficiently, and side reactions are likely to occur. On the other hand, when the weight average molecular weight of at least one of the carboxymethyl cellulose and the salt of carboxymethyl cellulose is more than 4.3×10⁵, at least one of the carboxymethyl cellulose and the salt of carboxymethyl cellulose is unlikely to be dissolved in the slurry for a negative electrode active material layer, and it becomes difficult to form a good negative electrode active material layer without pinholes.

The content of the carboxymethyl cellulose and the salt of carboxymethyl cellulose is preferably 0.1% to 1% by mass, and more preferably 0.2% to 0.8% by mass, relative to the total mass of the negative electrode active material layer. Furthermore, the carboxymethyl cellulose and the salt of carboxymethyl cellulose are preferably present in an amount of 0.1% to 1% by mass relative to the total mass of the covered graphite particles 20. In this case, the amorphous carbon particles 23 of the covered graphite particles 20 can be efficiently covered with the carboxymethyl cellulose and the salt of carboxymethyl cellulose. In the negative electrode active material layer, the content of the styrene-butadiene rubber is preferably 0.05% to 1% by mass, and more preferably 0.1% to 0.5% by mass, relative to the total mass of the negative electrode active material layer.

[Separator]

As a separator, a porous sheet having ion permeability and an insulating property is used. Specific examples of the porous sheet include a microporous thin film, woven fabric, and non-woven fabric. As the material for the separator, an olefin resin such as polyethylene or polypropylene, cellulose, or the like is suitably used. The separator may have either a single-layer structure or a multilayer structure. A heat-resistant layer or the like may be formed on the surface of the separator.

[Non-Aqueous Electrolyte]

A non-aqueous electrolyte includes a non-aqueous solvent and an electrolyte salt. As the non-aqueous solvent, for example, an ester, an ether, a nitrile such as acetonitrile, an amide such as dimethylformamide, or a mixed solvent containing two or more of these solvents may be used. The non-aqueous solvent may contain a halogen substitution product in which at least part of hydrogen atoms of the solvent described above is substituted with halogen atoms, such as fluorine. Examples of the ester include cyclic carbonic acid esters, such as ethylene carbonate (EC), propylene carbonate (PC), and butylene carbonate; chain carbonic acid esters, such as dimethyl carbonate (DMC), ethyl methyl carbonate (EMC), diethyl carbonate (DEC), methyl propyl carbonate, ethyl propyl carbonate, and methyl isopropyl carbonate; cyclic carboxylic acid esters, such as γ-butyrolactone (GBL) and γ-valerolactone (GVL); and chain carboxylic acid esters, such as methyl acetate, ethyl acetate, propyl acetate, methyl propionate (MP), and ethyl propionate.

Examples of the electrolyte salt include LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), and LiPF₆₋ₓ(CₙF₂ₙ₋₁)ₓ (1<x<6, n is 1 or 2). The concentration of the electrolyte salt can be set, for example, to 0.8 to 1.8 moles per one liter of the non-aqueous solvent. The non-aqueous electrolyte may contain, as the electrolyte salt, a difluorophosphate and a lithium salt having an oxalate complex as an anion.

The present disclosure will be further described below with reference to examples. However, it is to be understood that the present disclosure is not limited thereto.

### Example 1

[Formation of Positive Electrode]

As a positive electrode active material, a composite oxide represented by LiNi_{0.35}Co_{0.35}Mn_{0.30}O₂ was used. The positive electrode active material, PVdF, and carbon black were mixed at a mass ratio of 90:3:7, and the mixture was kneaded while adding N-methyl-2-pyrrolidone, thereby preparing a slurry for a positive electrode active material layer. Subsequently, the slurry for a positive electrode active material layer was applied onto both surfaces of a belt-shaped positive electrode core body formed of an aluminum foil with a thickness of 13 μm, and the resulting coating films were dried. The dried coating films were each compressed to a packing density of 2.5 g/cm³, followed by cutting to a predetermined electrode size, thereby obtaining a positive electrode having a positive electrode active material layer on each of both surfaces of the positive electrode core body. In addition, in the positive electrode, a positive electrode core body exposed portion to be connected to a positive electrode current collector plate was provided at one end in the width direction along the longitudinal direction of the positive electrode.

[Formation of Covered Graphite Particles]

Graphite particles obtained by forming natural graphite into spherical particles and carbon black, as a second amorphous carbon, having a BET specific surface area of 42 m²/g were mechanically mixed to form mixed particles in which carbon black particles adhered to the surfaces of the graphite particles. Pitch (a raw material for a first amorphous carbon) was added to and mixed with the mixed particles so that the pitch adhered to the surfaces of the mixed particles. The graphite particles, the pitch, and the carbon black were mixed at a mass ratio of 90:3:7. The graphite particles whose surfaces have adhering thereto the pitch and the carbon black were fired, in an inert gas atmosphere, at a temperature of 1,250° C. for 24 hours, and the resulting fired product was crushed to form covered graphite particles in which the fired product of the pitch, as the first amorphous carbon, and the carbon black, as the second amorphous carbon, adhered to the surfaces of the graphite particles.

In the covered graphite particle, the fired product of the pitch covered the entire surface of the graphite particle to form an amorphous carbon layer, and the amorphous carbon particles formed of the carbon black adhered to the surface of the graphite particle.

[Formation of Negative Electrode]

As a negative electrode active material, the covered graphite particles described above were used. The negative electrode active material and a sodium salt of carboxymethyl cellulose (CMC-Na) having a weight average molecular weight of 4.0×10⁵ were mixed, the mixture was kneaded while adding water, and a dispersion of styrene-butadiene rubber (SBR) having an average primary particle size of 180 nm was further added thereto, thereby preparing a slurry for a negative electrode active material layer. The negative electrode active material, the CMC-Na, and the SBR were mixed at a mass ratio of 99:0.6:0.4. Subsequently, the slurry for a negative electrode active material layer was applied onto both surfaces of a belt-shaped negative electrode core body formed of a copper foil with a thickness of 8 μm, and the resulting coating films were dried. The dried coating films were each compressed to a packing density of 1.2 g/cm³, followed by cutting to a predetermined electrode size, thereby obtaining a negative electrode having a negative electrode active material layer on each of both surfaces of the negative electrode core body. In addition, in the negative electrode, a negative electrode core body exposed portion to be connected to a negative electrode current collector plate was provided at one end in the width direction along the longitudinal direction of the negative electrode.

[Preparation of Non-Aqueous Electrolytic Solution]

In a mixed solvent obtained by mixing EC, EMC, and DMC at a volume ratio of 3:3:4 (at one atmospheric pressure and 25° C.), LiPF₆ was dissolved at a concentration of 1.15 M to prepare a non-aqueous electrolytic solution.

[Fabrication of Non-Aqueous Electrolyte Secondary Battery]

The positive electrode and the negative electrode were wound with a belt-shaped separator formed of polyolefin interposed therebetween, followed by press forming into a flat shape, thereby obtaining a flat winding-type electrode body. In this case, the positive electrode and the negative electrode were wound such that the positive electrode core body exposed portion was located at one end in the winding axis direction of the electrode body, and the negative electrode core body exposed portion was located at the other end in the winding axis direction. A positive electrode current collector that was electrically connected to a positive electrode terminal and fixed to a sealing plate was welded to the positive electrode core body exposed portion. A negative electrode current collector that was electrically connected to a negative electrode terminal and fixed to the sealing plate was welded to the negative electrode core body exposed portion. Then, the winding-type electrode body covered with an insulating sheet was inserted into a case. The sealing plate was welded to the case, and openings of the case were sealed with the sealing plate. After the non-aqueous electrolytic solution described above was injected from an electrolytic solution injection hole provided on the sealing plate, the electrolytic solution injection hole was sealed with a sealing plug, thereby obtaining a non-aqueous electrolyte secondary battery having a rated capacity of 4.1 Ah.

### Example 2

A battery was fabricated as in Example 1, except that, in the formation of covered graphite particles, carbon black having a BET specific surface area of 37 m²/g was used as the second amorphous carbon, instead of the carbon black having a BET specific surface area of 42 m²/g.

### Example 3

A battery was fabricated as in Example 1, except that, in the formation of covered graphite particles, carbon black having a BET specific surface area of 47 m²/g was used as the second amorphous carbon, instead of the carbon black having a BET specific surface area of 42 m²/g.

### Example 4

A battery was fabricated as in Example 1, except that, in the formation of the negative electrode, SBR having an average primary particle size of 150 nm was used instead of the SBR having an average primary particle size of 180 nm.

### Example 5

A battery was fabricated as in Example 1, except that, in the formation of the negative electrode, SBR having an average primary particle size of 210 nm was used instead of the SBR having an average primary particle size of 180 nm.

### Example 6

A battery was fabricated as in Example 1, except that, in the formation of the negative electrode, CMC-Na having a weight average molecular weight of 3.7×10⁵ was used instead of the CMC-Na having a weight average molecular weight of 4.0×10⁵.

### Example 7

A battery was fabricated as in Example 1, except that, in the formation of the negative electrode, CMC-Na having a weight average molecular weight of 4.3×10⁵ was used instead of the CMC-Na having a weight average molecular weight of 4.0×10⁵.

### Comparative Example 1

A battery was fabricated as in Example 1, except that, in the formation of covered graphite particles, carbon black having a BET specific surface area of 52 m²/g was used as the second amorphous carbon, instead of the carbon black having a BET specific surface area of 42 m²/g; that, in the formation of the negative electrode, CMC-Na having a weight average molecular weight of 3.3×10⁵ was used instead of the CMC-Na having a weight average molecular weight of 4.0×10⁵; and that, in the formation of the negative electrode, SBR having an average primary particle size of 130 nm was used instead of the SBR having an average primary particle size of 180 nm.

### Comparative Example 2

A battery was fabricated as in Comparative Example 1, except that, in the formation of the negative electrode, CMC-Na having a weight average molecular weight of 4.0×10⁵ was used instead of the CMC-Na having a weight average molecular weight of 3.3×10⁵.

### Comparative Example 3

A battery was fabricated as in Comparative Example 2, except that, in the formation of the negative electrode, SBR having an average primary particle size of 180 nm was used instead of the SBR having an average primary particle size of 130 nm.

### Comparative Example 4

A battery was fabricated as in Comparative Example 1, except that, in the formation of covered graphite particles, carbon black having a BET specific surface area of 42 m²/g was used as the second amorphous carbon, instead of the carbon black having a BET specific surface area of 52 m²/g.

### Comparative Example 5

A battery was fabricated as in Comparative Example 4, except that, in the formation of the negative electrode, SBR having an average primary particle size of 180 nm was used instead of the SBR having an average primary particle size of 130 nm.

### Comparative Example 6

A battery was fabricated as in Comparative Example 2, except that, in the formation of covered graphite particles, carbon black having a BET specific surface area of 42 m²/g was used as the second amorphous carbon, instead of the carbon black having a BET specific surface area of 52 m²/g.

[Evaluation of Low-Temperature Regeneration Characteristics]

Low-temperature regeneration characteristics (regeneration values) for the non-aqueous electrolyte secondary batteries according to Examples 1 to 7 and Comparative Examples 1 to 6 were obtained by the following method.

(1) Each of the batteries was charged under the condition of 25° C. until the state of charge (SOC) reached 50%.
(2) The battery having an SOC of 50% was charged, under the condition of −30° C., at current rates of 1.6 C, 3.2 C, 4.8 C, 6.4 C, 8.0 C, and 9.6 C, each for 10 seconds.
(3) The battery voltage immediately after each charging for 10 seconds was measured and plotted against the current value. A current value IP (A) at a battery voltage (V) corresponding to an SOC of 100% was obtained. A regeneration value (W) was calculated by multiplying the current value IP by the battery voltage (V) corresponding to an SOC of 100%. Table 1 shows, as the low-temperature regeneration characteristics (regeneration values), relative values obtained when the regeneration value of the battery of Comparative Example 1 is regarded as 100.

[Measurement of Initial Discharge Capacity]

The initial discharge capacity for each of the non-aqueous electrolyte secondary batteries according to Examples 1 to 7 and Comparative Examples 1 to 6 was obtained by the following method.

(1) Each of the batteries was charged at a constant current of 4 A until the battery voltage reached 4.1 V, and then, constant voltage charging was performed at 4.1 V (2 hours in total).
(2) Discharging was performed at a constant current of 2 A until the battery voltage reached 3.0 V, and then, constant voltage discharging was performed at 3.0 V (3 hours in total). The discharge capacity at this stage was defined as the initial discharge capacity.

[Evaluation of Cycle Characteristics]

The cycle characteristics (capacity retention rate after cycling) were obtained by the following method for each of the batteries whose initial discharge capacities were measured.

(1) Charging was performed at a constant current of 8 A until the battery voltage reached 4.1 V.
(2) Paused for 10 seconds.
(3) Discharging was performed at a constant current of 8 A until the battery voltage reached 3.0 V.
(4) With the steps (1) to (3) being defined as one cycle, 400 cycles were carried out under the condition of 60° C.
(5) Under the condition of 25° C., charging was performed at a constant current of 4 A until the battery voltage reached 4.1 V, and then, constant voltage charging was performed at 4.1 V (2 hours in total).
(6) Under the condition of 25° C., discharging was performed at a constant current of 2 A until the battery voltage reached 3.0 V, and then, constant voltage discharging was performed at 3.0 V (3 hours in total). The discharge capacity at this stage was defined as the discharge capacity after cycling.
(7) A capacity retention rate after cycling was calculated by dividing the discharge capacity after cycling by the initial discharge capacity. Table 1 shows, as the cycle characteristics (capacity retention rates after cycling), relative values obtained when the capacity retention rate after cycling of Comparative Example 1 is regarded as 100.

[Evaluation of High-Temperature Storage Characteristics]

The high-temperature storage characteristics (capacity retention rate after high-temperature storage) were obtained by the following method for each of the batteries whose initial discharge capacities were measured.

(1) Under the condition of 25° C., charging was performed until the state of charge (SOC) reached 80%.
(2) The battery having an SOC of 80% was stored under the condition of 75° C. for 56 days.
(3) Discharging was performed at a constant current of 2 A until the battery voltage reached 3.0 V, and then, constant voltage discharging was performed at 3.0 V (3 hours in total).
(4) Charging was performed at a constant current of 4 A until the battery voltage reached 4.1 V, and then, constant voltage charging was performed at 4.1 V (2 hours in total).
(5) Discharging was performed at a constant current of 2 A until the battery voltage reached 3.0 V, and then, constant voltage discharging was performed at 3.0 V (3 hours in total). The discharge capacity at this stage was defined as the discharge capacity after storage.
(6) A capacity retention rate after high-temperature storage was calculated by dividing the discharge capacity after storage by the initial discharge capacity. Table 1 shows, as the high-temperature storage characteristics (capacity retention rates after high-temperature storage), relative values obtained when the capacity retention rate after high-temperature storage of the battery of Comparative Example 1 is regarded as 100.

TABLE 1

| | BET specific | Average | Weight | | | |
|---|---|---|---|---|---|---|
| | surface area | primary | average | Low- | | High- |
| | of amorphous | particle | molecular | temperature | | temperature |
| | carbon particles | size of SBR | weight of | regeneration | Cycle | storage |
| | (m²/g) | (nm) | CMC-Na | characteristics | characteristics | characteristics |
| Comparative | 52 | 130 | 3.3 × 10⁵ | 100 | 100 | 100 |
| Example 1 | | | | | | |
| Comparative | 52 | 130 | 4.0 × 10⁵ | 97 | 101 | 105 |
| Example 2 | | | | | | |
| Comparative | 52 | 180 | 4.0 × 10⁵ | 102 | 105 | 106 |
| Example 3 | | | | | | |
| Comparative | 42 | 130 | 3.3 × 10⁵ | 95 | 104 | 103 |
| Example 4 | | | | | | |
| Comparative | 42 | 180 | 3.3 × 10⁵ | 103 | 109 | 104 |
| Example 5 | | | | | | |
| Comparative | 42 | 130 | 4.0 × 10⁵ | 94 | 104 | 107 |
| Example 6 | | | | | | |
| Example 1 | 42 | 180 | 4.0 × 10⁵ | 103 | 112 | 109 |
| Example 2 | 37 | 180 | 4.0 × 10⁵ | 102 | 114 | 111 |
| Example 3 | 47 | 180 | 4.0 × 10⁵ | 104 | 110 | 107 |
| Example 4 | 42 | 150 | 4.0 × 10⁵ | 101 | 109 | 107 |
| Example 5 | 42 | 210 | 4.0 × 10⁵ | 104 | 113 | 110 |
| Example 6 | 42 | 180 | 3.7 × 10⁵ | 104 | 112 | 108 |
| Example 7 | 42 | 180 | 4.3 × 10⁵ | 101 | 112 | 110 |

In Comparative Example 3, the BET specific surface area of the carbon black as amorphous carbon particles is 52 m²/g, and the cycle characteristics are low. In Comparative Example 6, the average primary particle size of the styrene-butadiene rubber is 130 nm, and the cycle characteristics and the low-temperature regeneration characteristics are low. In Comparative Example 5, the weight average molecular weight of the sodium salt of carboxymethyl cellulose is 3.3×10⁵, and the high-temperature storage characteristics are low.

In contrast, in Examples 1 to 7 in which the BET specific surface area of the carbon black formed of the second amorphous carbon as amorphous carbon particles is 37 to 47 m²/g, the average primary particle size of the styrene-butadiene rubber is 150 to 210 nm, and the weight average molecular weight of the sodium salt of carboxymethyl cellulose is 3.7×10⁵ to 4.3×10⁵, the low-temperature regeneration characteristics, the cycle characteristics, and the high-temperature storage characteristics are all excellent.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A non-aqueous electrolyte secondary battery comprising:
a positive electrode;
a negative electrode; and
a non-aqueous electrolyte,
wherein the negative electrode includes:
covered graphite particles in each of which a surface of a graphite particle is covered with amorphous carbon,
styrene-butadiene rubber, and
at least one of carboxymethyl cellulose and a salt of carboxymethyl cellulose;
wherein the amorphous carbon included in each of the covered graphite particles includes an amorphous carbon layer formed of a first amorphous carbon and amorphous carbon particles formed of a second amorphous carbon; and
wherein the second amorphous carbon has a higher electrical conductivity than the first amorphous carbon, the amorphous carbon particles have a BET specific surface area of 37 to 47 m²/g, the styrene-butadiene rubber has an average primary particle size of 150 to 210 nm, and at least one of the carboxymethyl cellulose and the salt of carboxymethyl cellulose has a weight average molecular weight of 3.7×10⁵ to 4.3×10⁵.

2. The non-aqueous electrolyte secondary battery according to claim 1, wherein the first amorphous carbon is a fired product of pitch.

3. The non-aqueous electrolyte secondary battery according to claim 1, wherein the second amorphous carbon is carbon black.

4. A method for manufacturing a non-aqueous electrolyte secondary battery which includes a positive electrode, a negative electrode, and a non-aqueous electrolyte,
wherein the negative electrode includes covered graphite particles in each of which a surface of a graphite particle is covered with amorphous carbon, styrene-butadiene rubber, and at least one of carboxymethyl cellulose and a salt of carboxymethyl cellulose;
wherein the amorphous carbon included in each of the covered graphite particles includes an amorphous carbon layer formed of a first amorphous carbon and amorphous carbon particles formed of a second amorphous carbon;
wherein the second amorphous carbon has a higher electrical conductivity than the first amorphous carbon; and
wherein the covered graphite particles are obtained by heating the graphite particles whose surfaces having adhering thereto the amorphous carbon particles with a BET specific surface area of 37 to 47 m²/g and a raw material for the first amorphous carbon, so that the raw material for the first amorphous carbon is transformed into the first amorphous carbon, the method comprising:
a step of preparing a slurry for a negative electrode active material layer including the covered graphite particles, styrene-butadiene rubber having an average primary particle size of 150 to 210 nm, and at least one of carboxymethyl cellulose and a salt of carboxymethyl cellulose having a weight average molecular weight of 3.7×10⁵ to 4.3×10⁵;
a step of applying the slurry for a negative electrode active material layer onto a negative electrode core body; and
a step of drying the slurry for a negative electrode active material layer.

5. The method for manufacturing a non-aqueous electrolyte secondary battery according to claim 4, wherein the raw material for the first amorphous carbon is pitch.

6. The method for manufacturing a non-aqueous electrolyte secondary battery according to claim 4, wherein the second amorphous carbon is carbon black.
